(19) United States
(12) Patent Application Publication
(10) Pub. No.: US 2026/0033523 A1
(43) Pub. Date: Feb. 5, 2026

(54) SUGAR-REPLACING COMPOSITIONS WITH NO TRADITIONAL SWEETENERS

(71) Applicant: SweetScience LLC, Tarzana, CA (US)

(72) Inventor: Ori HOFMEKLER, Tarzana, CA (US)

(73) Assignee: SweetScience LLC, Tarzana, CA (US)

(21) Appl. No.: 19/285,731

(22) Filed: Jul. 30, 2025

Related U.S. Application Data
(60) Provisional application No. 63/677,663, filed on Jul. 31, 2024.

(51) Int. Cl. A23L 27/30; A23G 1/40; A23G 1/48; A23L 27/12

(52) U.S. Cl. CPC A23L 27/30; A23G 1/40; A23G 1/48; A23L 27/12

(57) ABSTRACT

A sugar replacing composition has no traditional sweeteners that contain novel ingredients with added health benefits and provides sweetness characteristics of sugar without the aftertaste of sweeteners and without the glycemic load of sugar. Specifically, the sugar replacer composition includes digestion resistant soluble fiber comprising an oligosaccharide matrix of glucose and/or fructose and/or xylose oligomers with digestive resistant properties, along with a freeze dried extract from the endosperm of the coconut fruit and/or a freeze-dried extract from the pulp of the banana fruit, where the ingredients contribute to the added health benefits and the sweetening capacity of the composition.

### BACKGROUND OF THE INVENTION

It is known in the culinary arts that the sweetness of food depends on how it is perceived by the human sensory system. For instance, dark chocolate is perceived as less sweet than milk chocolate due to bitter compounds in dark chocolate that mask the sweetness of dark chocolate and render it less sweet than milk chocolate. This is so when both have the same content of sugar, indicating that the void of bitter compounds in food can be perceived as increased sweetness. Reducing sugars can act as reducing agents in food material to form Maillard reaction products, and, given that Maillard reaction products can act as chelating agents towards bitter compounds, such as metal ions or ascorbate which often occur in food.

Redox and Maillard reactions are commonly used by those skilled in the art as culinary means to affect the color, aroma, and flavor of food. These reactions have not been used as strategic means for sweetening pertaining to sweeteners when defined as sweet molecules or compounds other than sugar that are branded and used as sweeteners.

It is known among those skilled in the art that, among food materials, chocolate is one of the most sensitive to flavors changes and is likely to exhibit afternotes such as those of sweeteners. It is for this reason that chocolate is a most challenging material in which to find suitable replacements for sugar and one of the most difficult materials of which to determine proof-of-concept of for low calorie sugar replacements.

Sugar replacers may be derived from chemical or natural sources, yet they all lack sweetness characteristics of sugar when used in edible products. High intensity natural sweeteners, such as stevia and monk fruit, have a notable aftertaste with a lingering sweet taste. High intensity artificial sweeteners, such as sucralose, aspartame and acesulfame potassium, also impart these undesirable aftertastes. Sugar alcohols have a distinct aftertaste as well and have been shown to cause digestive and health issues which generally limit their use in edible foods and as sugar substitutes. Sugar substitutes containing combinations of sugar alcohol(s) and stevia, and/or monk fruit have not yet been successful in replicating the taste and function of sugar. This problem is also present with man-made sugar substitutes, such as allulose.

In order to mimic the binding function of sugar, sweeteners are commonly combined with binding agents such as sugar alcohol and maltodextrin or sometimes combined with the same fiber ingredients as in examples of the composition described herein. Yet still none of these has been successful in eliminating the lingering aftertaste associated with sweeteners. Food products containing sweeteners are generally mixed with additional ingredients such as flavorings, masking agents, acids, mineral salts, sodium chloride, more sweeteners or even sugar in attempt to attune the lingering aftertaste associated with sweeteners.

Accordingly, there exists a need for a low calorie sugar replacement that contains no traditional sweeteners and provides a clean sweetness taste with no lingering aftertaste and without the need for additional ingredients to mask aftertaste.

### SUMMARY OF THE INVENTION

The invention encompasses a sugar replacing composition with no added sweeteners comprising: digestion resistant soluble fiber having glucosyl moieties and/or fructosyl moieties, and/or xylosyl moieties, and present in an amount of 49% to 99% by weight of the composition; dried coconut extract from the endosperm of coconut fruit namely coconut water in an amount of 6%-18% by weight of the composition; and flavor agent comprising a dried rice extract and/or dried barley extract, and/or a dried vanilla flavor and/or a dried fruit extract, or a combination thereof, and the flavor agent present in an amount of 0.2% to 0.5% by weight of the composition.

In one embodiment of the invention the resistant soluble fiber is at least one of resistant dextrin and/or inulin and/or xylooligosaccharides (XOS), and the resistant dextrin is made without sugar alcohol processing aid, but may instead comprise a soluble fiber processing aid such as XOS and/or inulin comprised in a content of up to 18% by weight of resistant dextrin. In another embodiment, the digestion resistant soluble fiber is derived from a food source selected from the group consisting of tapioca, corn, potatoes, peas, banana, plantain, chicory, Jerusalem artichoke, or combinations thereof. In yet another embodiment, the digestion resistant soluble fiber is present along with or replaced by other digestive resistant material from the group consisting of digestion resistant oligomers such as isomaltooligosaccharides or galactooligosaccharides, or digestive resistant five carbon monomers such as xylose, or combination thereof, in an amount of 40%-95% by weight of the composition.

In one embodiment of the invention, the coconut extract is replaced with dried banana extract and the dried banana extract is incorporated in the composition at the same percentage of the replaced coconut extract by weight of the composition. In another embodiment, the flavor agent is a food extract present in an amount of 8% to 17% by weight of the composition. In yet another embodiment, the sugar replacing composition may further comprise at least one fruit extract. The fruit extract may be dried banana extract. In one embodiment of the invention, the fruit extract is present in an amount of 6%-18% by weight of the composition.

The invention also encompasses a method of creating a low calorie food material comprising: adding a sugar replacing composition comprising: digestion resistant soluble fiber comprising glycosyl moieties and/or fructosyl moieties, and/or xylosyl moieties, present in amount of 49% to 99% by weight of the composition; adding dried coconut extract from the endosperm of the coconut fruit and/or a dried banana extract in an amount of 6% to 18% by weight of the composition; and adding flavor agent comprising natural vanilla and/or rice extract and/or a barley extract and/or a vanilla flavor or a combination thereof, in an amount of 0.2% to 1.5% by weight of the composition.

In another embodiment of the invention, the food material is any food or nutritional product that is melted and/or softened and/or hardened and/or heated and cooled during making, wherein the food material is chocolate comprising cocoa liqueur and/or cocoa butter and/or dried milk and adding a low glycemic sugar replacer composition according to claim 10, present in an amount of 15% to 45% by weight of the chocolate material along with dried Milk (Non-Fat and/or Whole Milk) whereas the dry milk is present in an amount of 2% to 20% by weight of dark chocolate and 20% to 40% by weight of milk or white chocolate. In another embodiment, the method may further comprise adding at least one dried fruit extract in an amount of 3% to 10% by weight of the food material. In yet another embodiment, the food material is an ingredient mix for baking and the composition is added in an amount of 10%-50% by weight of the ingredient mix. In one embodiment, the food material is an ingredient mix for ice-cream and the composition is added in an amount of 10% to 50% by weight of the ingredients mix. In yet another embodiment, the food material is an ingredient mix for baking, granola, cereal, puffed grains, trail mix, nutrition bar, candy bar, ice cream, whipped cream, beverage creamer, yogurt, frozen desert, custard, pudding, pie, bread, crackers, pastry, cake, nut butter, protein powder, meal replacement, vitamins, fruit powder, milk powder, cocoa beverage, tea beverage, coffee beverage, waffle, pancake, biscuit, tortilla, gummy bears and confection products, and the composition is added in an amount of 10% to 50% by weight of the ingredient mix.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a spider graph representing the test profile for a milk chocolate using a composition of the invention, as described in Example 4.

FIG. 2 illustrates a spider graph representing the test profile for a white chocolate using a composition of the invention, as described in Example 5.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The invention is directed to a sugar replacing composition that has no traditional sweeteners and contains novel ingredients with added health benefits, and that provides sweetness characteristics of sugar without the aftertaste of sweeteners and without the glycemic load of sugar.

The invention is directed to a sugar replacing composition comprising no added sweeteners (including traditional sweeteners, artificial sweeteners, natural sweeteners, and man-made sweeteners, as defined below), such as sucrose, glucose, fructose, sucralose, allulose, stevia, monk fruit, sugar alcohol, etc., that contains ingredients with health benefits and provides sweetness characteristic of sugar without the aftertaste of sweeteners and/or the glycemic load of sugar. Any sugars contained within the ingredients of the composition, such as natural ingredients are not considered added traditional sweeteners and are excluded from this term. Not to be limited by theory, it is believed that the present composition is unlike current sugar substitutes that have at least one sweetener in their composition. The sugar replacing composition herein has no traditional sweeteners (as commonly understood by the skilled artisan and exemplified below), has no artificial sweeteners (such as sucralose, aspartame, or acesulfame potassium), does not contain natural sweeteners (such as Stevia, monk fruit, allulose and sugar alcohol) in its composition and does not contain glycemic oligosaccharides that are easily digestible such as maltodextrin.

The invention includes a sugar replacing composition that contains no sweeteners, where the term “sweetener” pertains to a sweet molecule or a compound other than sugar and often sweeter than sugar that is branded and used as a stand-alone sweetener to sweeten dietary products. According to one or more examples, the sugar replacing composition comprises a digestion resistant soluble fiber, a coconut endosperm extract, and/or banana pulp extract, and a flavor agent. The composition also excludes one or more of traditional sweeteners (as defined herein), artificial sweeteners, natural sweeteners, or man-made sweeteners. The term “traditional sweeteners” includes monosaccharides or disaccharides and easily digestible oligosaccharides (such as digestible maltodextrin), but not digestive resistant oligosaccharides or polysaccharides. Traditional sweeteners include, but are not limited to, sucrose, glucose, lactose, dextrose, fructose, maltose, galactose, mannose, allose, altrose, maltose, sorbose or digestible maltodextrin. Artificial sweeteners include, but are not limited to, saccharin, sucralose, aspartame, acesulfame potassium, or lacsucralose. Natural sweeteners include, but are not limited to stevia, monk fruit, or sugar alcohols (such as maltitol, sorbitol, and xylitol). Man-made sweeteners include, but are not limited to allulose or erythritol. The term ‘man-made’ refers herein to lab-made sweetening compounds which are unlike nature-extracted sweetening compounds.

Not to be limited by theory, during trials of the invention it was noticed that when embodiments of the sugar replacing composition were applied to chocolate, these sugar replacers seemed ‘activated’ by chocolate material in that they functioned as if catalyzed during the processing of the chocolate to induce flavor changes and sweetening in a manner that has not been seen among sweeteners. It is believed that the flavor changes can be nonetheless attributed to reducing agents and the induction of Maillard reactions in applications of such. There is a reason to believe that the manner by which the sugar replacing composition sweetened chocolate has to do with chelation of bitter compounds that occur in chocolate.

However, this function is unique to the sugar replacing composition of the invention and the sugar replacing composition seemed to be awakened from a ‘dormant’ state into an ‘activated’ state by materials such as chocolate during the processing of the chocolate and thereby induce flavor changes and sweetening in a manner that is different than the manner by which sweeteners typically function. This is in contrast with the knowledge in the art that sweeteners typically function with the same manner of sweetening upon food items and leave a distinct aftertaste that lingers in the palate.

Specifically, the sugar replacer composition comprises digestion resistant soluble fiber comprising an oligosaccharide matrix of glucose and/or fructose and/or xylose oligomers with digestive resistant properties, a freeze dried extract from the endosperm of the coconut fruit, and/or a freeze dried extract from the pulp of the banana fruit. These ingredients contribute to the added health benefits and the sweetening capacity of the composition. The freeze dried extract from the endosperm of the coconut fruit namely coconut water referred herein as coconut extract, such as dried coconut water The pulp of the banana fruit is referred herein as banana extract.

A particular composition may comprise a digestion resistant soluble fiber, a coconut extract, and a flavor agent (such as vanilla, and/or Oryza sativa (rice) extract) and/or a fruit extract. Another particular composition does not include sweeteners including traditional sweeteners, artificial sweeteners, natural sweeteners, and man-made sweeteners. These particular compositions may further comprise a banana extract, and/or barley extract.

The digestion resistant soluble fiber comprises an oligosaccharide matrix of glucose and/or fructose and/or xylose oligomers with digestive resistant properties that allows the use of xylooligosaccharides (XOX). Oligosaccharide and polysaccharide matrices with digestive resistant properties are not included in the term traditional sweeteners or sweeteners.

Dietary fibers were shown to exert notable metabolic benefits including improvement of insulin resistance and lowering the risk of diabetes. Various fiber types have been studied for their health benefits but often found to induce intestinal discomfort even at small dosage. Among digestion resistant soluble fibers, resistant dextrin exhibited tolerance in typical serving size of food products. Herein, tolerance means digestive tolerance where a typical serving size is 30 g of chocolate or cereal.

The digestion resistant soluble fiber may be derived from a variety of starchy food sources such as corn, tapioca, potatoes, peas, plantain, banana, pumpkin, oats, barley, or wheat; or a variety of plant root sources such as chicory or Jerusalem artichoke. The digestion resistant soluble fiber may comprise glucose and/or fructose and/or xylose oligomers. The glucose oligomers-based fiber, such as resistant dextrin, comprises an oligosaccharides matrix with alpha-D (1,6) linkage of various chain length which is not hydrolyzed by human intestinal enzyme and yield the fiber digestion resistant properties, generally with at least 50% of the glycosyl moieties linked by alpha (1,6) linkage. The digestion resistant soluble fiber may comprise fructose oligomers, such as Inulin, generally with at least 80% of the fructose moieties linked by beta (2,1) linkage, which cannot be digested by human intestinal enzymes and yield the fiber digestion resistant properties. The digestion resistant soluble fiber may comprise xylose oligomers, such as XOS fiber, that are linked by beta (I, 4) linkage with a degree of polymerization (DP) that ranges between 2 to 12. All the fibers described herein are low glycemic and prebiotic, and have been used to decrease calorie intake, provide binding capacity and add fiber in food applications for health purposes.

Resistant dextrin is a soluble fiber derived from wheat, corn, peas, or tapioca starch. It is prepared by strictly controlled process of partial hydrolysis and repolymerization. The preparation process of resistant dextrin often involves the use of a processing aid in the form of sugar alcohol which may remain in the final product in a content of up to 18% by weight of the final product. An example of resistant dextrin is the commercial product FiberSmart by Anderson Global. The invention herein pertains to replace the sugar alcohol processing aid with a soluble resistant fiber such as xylooligosaccharides (XOS) and/or inulin, and thereby yield the final resistant dextrin product a higher content of soluble fiber with a cleaner label free of sugar alcohol.

Animal and human studies have shown that resistant dextrin fiber can help improve determinants of metabolic syndrome as well as insulin resistance and inflammation. Similar health benefits have been attributed to Inulin and xylooligosaccharides (XOS).

XOS is a resistant oligosaccharide fiber with anti-inflammatory immune supporting and prebiotic properties. Composed of d-xylose units that are linked by beta I, 4 glycosidic bonds, XOS is naturally occurring in vegetables, fruits and honey, and can be formed as a byproduct of hemicellulose breakdown during fiber degradation. Aside from contributing sweetness and health properties, XOS enhances the functional properties of the composition with increased resistance to acidity and heat and increased retention of moisture, which can be particularly useful in applications such as baking, ice cream and food bars.

A peak in the sweetness of the sugar replacing composition was noticed when the fibers components were combined in a particular ratio. At a ratio range of 5:2:3 to 8:1:1 by weight of resistant dextrin- to inulin -to XOS, the combined fiber mix yielded peak sweetness. The percentage of each of the fiber components was calculated in consideration of granting both sweetness and digestive tolerance to the composition as a whole. This ratio of combined digestive resistant fibers with plant extracts in the composition, as described in examples of the composition hereinbelow, has shown to contribute sweetness characteristics of sugar without the use of sweeteners.

Dried coconut water is a novel ingredient in the field of sugar substitutes or sweeteners. An extract of the endosperm of the coconut fruit in a dried form, dried coconut water has been generally used as a natural source of electrolytes, but due to its salty taste and often woody aftertaste has not been used as a stand-alone sweetener or ingredients in a sugar substitute composition nor has it been branded as such. Not to be limited by theory, Applicant has noticed that composition having dried coconut water (referred herein as coconut extract) was applied to replace sugar when used in chocolate, the chocolate exhibited changes in flavor and sweetness in a magnitude that was beyond what was initially expected, while the coconut extract with its reducing sugars was the only ingredient in the compositions that could act as a reducing agent towards the chocolate material to potentially induce such an effect.

The coconut extract in the sugar replacing composition is a freeze-dried extract of a clear liquid from the endosperm of the coconut fruit namely coconut water. It contains a high level of electrolytes, notably potassium, magnesium, sodium, and calcium, along with trace vitamins, antioxidants, amino acids (gamma amino butyric acid, alanine, arginine, glutamic acid, tryptophan, cysteine), organic acids (malic acid, citric acid), trace enzymes, cytokines (kinetin, trans-Zeatin), and a unique profile of six and five carbon reducing sugars including glucose, fructose and xylose, which yet keep the hypoglycemic properties of the extract. Although coconut water may contain glucose, the composition of the invention does not contain glucose in addition to that naturally found in coconut water. Coconut extracts from immature fruits have a higher content of monosaccharides and may cause redox interactions with food material under a neutral to alkaline pH of above 6.5, whereas extracts from mature fruits have a higher content of di-saccharides and may cause redox interactions with food material under an acid pH of below 6.5.

It is to be known that although coconut water is already well studied in terms of its chemical content and biological properties, there are unknown factors related to its dried extract that may induce special organoleptic effects in applications to food material. The freeze dried coconut water in the composition referred herein as coconut extract, has shown to induce a sweetening effect notably beyond its own level of sweetness and despite its original salty flavor. Such sweetening effect was noticed when embodiments with coconut extract were applied to a chocolate that was processed through conventional methods known in the art.

The coconut extract may be used in the composition when the composition is in a powdered, syrup, or liquid form, to improve taste and potentiate the sweetness contributed by the composition. The content of coconut extract in the composition may vary, depending on the make-up of the composition. For example, a greater amount of coconut extract may be used if the composition comprises coconut extract with no additional fruit extract, as opposed to when the composition comprises coconut extract along with an additional fruit extract, wherein less coconut extract may be used.

Coconut extract includes coconut water that is a clear liquid from the endosperm of the coconut fruit which differs from the oily white liquid of the grated kernel namely coconut milk. Freeze dried coconut water comprises distinct metabolic supportive nutrients and like liquid coconut water has been attributed biological properties including hypoglycemic, hypolipidemic and protective potential against diabetes. The production of freeze-dried coconut water involves collection of fresh coconut water generally from a fruit variety with different maturity, which is then frozen at about minus 30° C. for 48 hours and then vacuum dried into crystals. Methods to prepare this coconut extra are found in Hariyadi, “Freeze Drying Technology: for Better Quality & Flavor of Dried Products,” Food Rev. Indones., 2013, 7, 52-7 and Boonnumma et al., “Freeze-dried coconut water powder processing for natural health drink,” Acta Hortic, 2014, 1023, 91-94.

Liquid coconut water, although widely used as an ingredient in functional drinks for hydration and healing, has not been considered suitable for use in sugar replacement due to its low sugar contents (2%-3% by weight) and often woody aftertaste. The same understanding applies to its dried extract which is typically salty due to its high content of mineral salts. This is unlike coconut sugar which is derived from the nectar of the coconut palm and has been used as sugar to sweeten dietary products.

Coconut extracts from immature and mature fruits, such as Dwarf and Tall varieties, are available as products of India, the Philippines, Hawaii, Sri Lanka and Indonesia.

The coconut extract may be combined with or replaced by a dried extract from the pulp of the banana fruit (refers herein as banana extract), which similar to coconut extract is a novel ingredient in the field of sweeteners. Banana is mainly a flavorant and has not been explored in the field as a stand alone sweetener or branded as such. That is due to its content of insoluble fiber, insoluble starch and high gelatinization, which render banana and its extract insoluble, too gelatinous and too “banana-y” to function as a stand alone sweetener. Yet in trials pertaining to the invention, embodiments of the sugar replacer with banana extract have been shown to sweeten chocolate in a manner that was different than otherwise expected from sweeteners in applications of such. It was noticed that after a settling down period of three to four weeks, the sweetness of the chocolate was further enhanced while any trace of banana flavor seemed to have faded out. A similar sweetness enhancement effect was noticed in chocolate that was made with embodiments comprising coconut extract, after the chocolate was let cure for three to four weeks. Just like embodiments with coconut extract that exhibited a novel manner of sweetening in chocolate, so did embodiments with banana extract with their content of reducing saccharides and fibers, as both extracts have shown to function as if catalyzed by chocolate material to induce a peak sweetening effect during the processing of the chocolate, an effect that was further enhanced after a settling down period of three to four weeks.

It is to be known that banana extracts from young fruits have a higher content of reducing sugars and antioxidants than extracts from mature fruits. Nonetheless, freeze dried banana extract from natural fruits with their higher content of non-reducing sugars, can still induce a notable sweetening effect in some applications under an acidic pH.

Embodiments of the composition with banana extracts from mature fruits may better suite food material with acidic pH such as non-alkalized chocolate; whereas embodiments with banana extracts from young fruits may better suit food material with neutral to alkaline pH such as alkalized chocolate.

The replacement of coconut extract with dried banana extract in the sugar replacing composition should be done pound for pound (1×1) where the banana extract is incorporated at the same percentage of the replaced coconut extract by weight of the composition.

Dried banana extracts are produced through several drying methods including Hot Air Drying, Vacuum Drying, Drum Drying and Freeze Drying, among which Freeze Drying is the preferred method. The Freeze drying of banana with the absence of liquid under a freezing temperature yields best quality with minimum loss of material. Dried banana extracts are available as products of India, Chile, Mexico, Indonesia and the USA, among other countries. Methods for preparing the banana extract are found in of production citation: Anyasi, et al., “Functional properties and postharvest utilization of commercial and noncommercial banana cultivars,” Comprehensive Reviews in Food Science and Food Safety, 2013, 12, 509-522 and Zhang, et al., “Banana starch: production, physicochemical properties, and digestibility—a review,” Carbohydrate Polymers, 2005, 59, 443-458.

Particularly unique to coconut and banana extracts is the content of reducing sugars. Reducing sugars act as reducing agents due to having a free aldehyde or ketone group in their molecular structure. It is believed that reducing sugars, such as those in the embodiments, can act as reducing agents to change the organoleptic profile of food material if the food material is processed in a manner similar to chocolate. In other words, the food material is melted or otherwise softened into a material that enables the reducing agents to catalyze Maillard reactions and thereby affect the chemical constitution of the food along with its flavor and sweetness. For instance, if the food material is melted or softened into a substrate that enables Maillard reactions while it comprises bitter reactive elements such as metal ions, the reducing agents in the sugar replacing composition will interact with food material to form Maillard reaction products that may act as chelating agents toward the reactive elements and render the food less bitter and sweeter.

Reducing sugars are small saccharides with a free aldehyde or ketone group in their molecular structure that enable them to act as reducing agents. It is known in the art that reducing sugars can act as reducing agents towards reactive compounds in food where they catalyze Maillard reactions that affect the chemistry and taste of food. Maillard reactions occur when a carbonyl compound such as a reducing sugar condenses with a compound that comprises a free amino group such as an amino acid of a protein, in a process that involves different steps and forms Maillard reaction products which are responsible for to the color, taste, aroma and flavor of food items.

It was noticed in trials with chocolate pertaining to the invention, that despite being a non-reducing saccharide, sucrose may still act as a reducing agent in the composition but under an acidic pH such as that of cocoa in chocolate. The acidity of cocoa in chocolate may cause the sucrose in the extracts to convert from its original cyclic form into an open chain with a free hemiacetal and aldehyde group which render it a reducing sugar. The open chain sucrose molecule may act as a reducing agent to form Maillard reactions products which cause changes in flavor and sweetness, but includes calories that are unwanted in a sugar substitute sweetener. However, sucrose yielded an organoleptic note similar to that noticed with sugar replacing compositions having coconut and/or banana extract from mature fruits, when the composition replaced sugar in chocolate.

In some compositions comprising coconut and/or banana extracts from young immature fruits with their higher content of monosaccharides may better suit alkaline or alkalized food material such as alkalized chocolate; whereas embodiments that comprise coconut and/or banana extract from mature fruits may better suit neutral to acid food material such as non-alkalized chocolate.

The flavoring agent may comprise one or more of vanilla extract, vanilla flavor, Oryza sativa (rice) extract, barely extract, and/or plant extract such as of cocoa, ginger, cinnamon, birch, or a fruit. The flavoring agent may be used to add flavor and optimize sweetness but not to mask aftertaste. The ingredients and formulations of the flavoring agent may vary depending on the type of sugar substitute. In some examples a greater amount of Oryza sativa (rice) extract and/or barley malt extract is used to mimic the flavor of brown sugar for instance, as opposed to examples with greater amounts of vanilla or ginger intended to mimic the flavor of vanilla sugar or ginger sugar. Unlike typical flavor masking agents that are used in attempt to mask aftertaste such as that of sweeteners, the flavor agents in the composition do not pertain to mask aftertaste but rather add flavor and optimize the sweetness of the composition to resemble that of sugar.

Flavor agents include, but are not limited to, maple, honey, cane, malt, salt, malted milk, oat milk, rice extract, barley malt extract, milk, milk minerals, buttermilk, whey, caramel, cream, coffee, cocoa, coconut, carrot, pumpkin, peanut, almond, hazelnut, ginger, cardamon, turmeric, cinnamon, apple, berries, banana, and citrus. Each flavor agent in the composition if comprised of an extract of a food source be it a fruit, a root, seed or a grain, may fall under the category of a food extract which is generally applied in greater percentage ranges than those of typical flavoring agents.

The contributed sweetness of the composition was measured in comparison to that of sugar per amount used in chocolate application. Accordingly, the amount of the composition needed to provide sweetness equivalent to 30% sugar in chocolate was about 40% by weight of the chocolate. The sweetness contributed by the composition when applied to chocolate was likely achieved due to the functional synergy and distinct ratio between the combined ingredients as well as the content of reducing agents in the composition.

The composition described herein has a sweetness range equivalent to 50%-80% sucrose, nonetheless, due to its enhanced sweetening effect as noticed in applications to food material such as chocolate, the composition may be used to replace sugar using a ratio of 1:1 to 2:1 by weight of composition to sugar. It is to be understood that the invention herein pertains to a fiber-based composition suitable to replace sugar in chocolate comprising up to 50% sugar by weight of chocolate (such as typical milk chocolates), yet when applied to replace sugar beyond the 50% threshold content by weight of chocolate, the composition may yield a harder texture that may be less desirable.

The sugar replacing composition is also suitable to lower the content of sugar and sweeteners in dietary products. For example, when applied to food material such as chocolate in a percentage range of 10% to 30% by weight of chocolate, the composition may lower the content of sugar by up to five fold, such as from a typical content of 50% sugar to a content of 10% sugar by weight of chocolate, while keeping desirable sweetness with no aftertaste. Alternatively lower the content of sweeteners such as stevia or monk fruit by up to ten fold, such as from a typical content range of 0.07%-0.1% sweetener to a content range of 0.01%-0.03% sweetener by weight of chocolate, while keeping desirable sweetness with no aftertaste.

The sugar replacing composition described herein is provided in solid and liquid forms such as powder, granules and syrup. The composition may be used to replace or lower the content of sugar and/or sweeteners in nearly any food or nutritional product or ingredients mix of any food or nutritional product that is melted and/or softened and/or hardened in the making and used in consumers or industrial applications including chocolate, compound chocolate, confection, baking goods, waffles, pancakes, granolas, cereals, ice cream, creamers, yogurt, frozen desserts, tea powders, coffee powders, cocoa powders, candy bars, nutrition bars and protein powders.

### Examples

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The following examples illustrate embodiments of the invention pertaining to replace or reduce the content of sugar and sweeteners in chocolate. The chocolate examples were processed through conventional methods known in the art and the composition was applied to each of the examples the same way that sugar is applied to chocolate. The conching of the chocolate was extended beyond 15 hours to grant each product authentic creamy texture. The percentage of ingredients in the recipes was measured by weight of chocolate. The percentage of ingredients in the composition was measured by weight of the composition.

### Materials

Soluble Resistant dextrin powder was obtained from Anderson Global. Botanical source: Cassava. Inulin was obtained from Anderson Global. Botanical source: Jerusalem artichoke. Xylooligosaccharides fiber (XOS) was obtained from Anderson Global. Botanical source: Corn. Coconut Water powder Freeze dried was obtained from Select Ingredients. Botanical source: coconut. Banana pulp Extract Freeze Dried was obtained from Southern Freeze Dry SPA, Chile. Botanical source: Musa Paradisiaca. Natural Vanilla flavor was obtained from Anderson Global. Rice Extract was obtained from RIBUS Inc, St. Louis, MO, USA (Nu-Flow). Botanical Source: Oryza Sativa. Unsweetened chocolate (cocoa liqueur, cocoa butter) was obtained from Barry Callebaut North America. Non-Fat Dry Milk powder was obtained from Continental Dairy Facilities, LLC, Coopersville, MI USA. Whole Milk Powder was obtained from Continental Dairy Facilities LLC, Coopersville, Mi USA. Stevia extract was obtained from Barry Callebaut; Anderson ingredients. Botanical source: Stevia Rebaudiana.

### Example 1

The sugar replacing composition comprises a soluble digestion resistant dextrin fiber, inulin, XOS, coconut extract and a flavor agent comprising rice extract and vanilla in the following % ranges by weight of the composition: Soluble digestion resistant dextrin fiber 70%-88%; Inulin 3%-15%; XOS 2%-18%; Coconut extract 6%-18%; Rice extract 0.2%-1.5%; Vanilla 0.2%-0.8%.

### Example 2

The sugar replacing composition comprises soluble digestion resistant dextrin fiber, XOS, Inulin, coconut extract, vanilla, and rice extract in the following % ranges by weight of the composition: soluble digestion resistant dextrin fiber 58%-85%; XOS 5%-20%; Inulin-3%-7%; coconut extract 6%-18%; vanilla 0.2%-0.5%; rice extract 0.2%-1.3%.

### Example 3

The sugar replacing composition comprises soluble digestion resistant dextrin fiber, XOS, Inulin, banana pulp extract and a flavoring agent comprising vanilla and barley malt extract in the following % ranges by weight of the composition: soluble resistant dextrin fiber 58%-85%; XOS 10%-20%; Inulin 3%-7%; banana extract 6%-18%; barley malt extract 5%-13%; vanilla 0.1%-0.5%.

In yet one or more embodiments, other digestion resistant matters comprising oligomers and/or five carbon monomers are possible within the scope and spirit of the innovation.

### Example 4: Milk Chocolate with No Added Sweeteners

The following sugar replacing composition resulted from trials that aimed to establish optimal ratios between the sugar replacing composition and chocolate material and create milk chocolate with no added sugar and no added sweeteners. In making the composition and milk ingredients were added to a melted unsweetened chocolate comprising cocoa liqueur and cocoa butter, combined into a blend which was processed through conching and tempering and then molded into chocolate chips.

Using weights as a percentage of the sugar replacing composition, unsweetened chocolate (Cocoa Liqueur, Cocoa Butter) 30%; non-fat dry milk powder 10%; whole milk powder 20%; and the sugar replacing composition (resistant dextrin 70%; XOS 10%; coconut extract 16%; Inulin 3.3%; rice extract (rice hull) 0.5%; and Vanilla 0.2%) 40% were mixed.

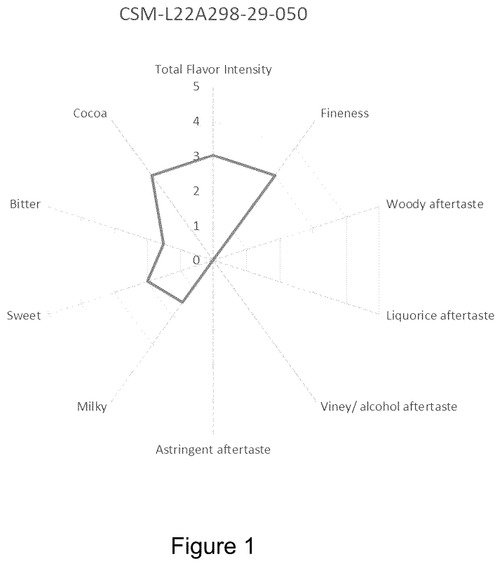

The results yielded a lightly sweet Milk chocolate with authentic taste and no aftertaste. FIG. 1 illustrates a spider graph detailing the flavor profile of this composition that reflects the results of a sensory trail with a panel of 10 professional testers that evaluated Milk chocolate made with the composition of this example and no added sugar. The graphs demonstrates that the composition has no aftertaste. The Bitter flavor is approximately one and a half for this composition due to the content of cocoa liqueur. In milk chocolate, the most notable flavors were Milky and Sweet.

### Example 5: White Chocolate with No Added Sweeteners

The following example resulted from trials that aimed to establish optimal ratios between the composition, milk ingredients and cocoa butter and create white chocolate with no added sugar and no added sweeteners. In the making of this example, the composition and milk ingredients were added to a melted cocoa butter and combined into a blend which was then processed through conching and tempering and molded into chocolate chips.

The ingredients are given as a percentage of the final composition. Cocoa butter—30%; sugar replacing composition (resistant Dextrin 70%; XOS 10%, Banana extract 16%; Inulin 3.3%; Rice Extract (Rice Hull) 0.5%; Vanilla 0.2%) 40%; non-fat dry milk powder 10%; and whole milk powder 20% were mixed.

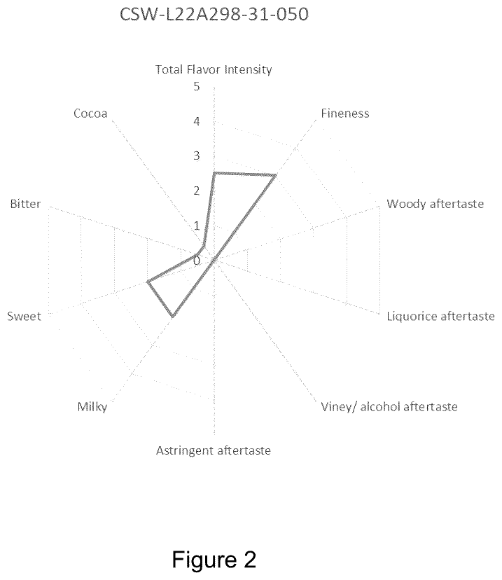

The results yielded a lightly sweet white chocolate with authentic taste and no aftertaste. FIG. 2 illustrates a spider graph detailing the flavor profile of this composition that reflects the results of a sensory trail with a panel of 10 professional testers that evaluated white chocolate made with the composition of this example and no added sugar. The graphs demonstrates that the composition has no aftertaste. The Bitter flavor is very low. In white chocolate, the most notable flavors were Milky and Sweet.

### Example 6: Dark Chocolate with No Added Sweeteners

The following example resulted from trials that aimed to establish the right ratio between the composition and unsweetened chocolate comprising cocoa liqueur and cocoa butter and create semi-sweet dark chocolate with no added sugar and no added sweeteners. In the making of this example, the composition was added to a melted unsweetened chocolate and combined into a blend which was then processed through conching and tempering and molded into chocolate chips.

Unsweetened chocolate (Cocoa Liqueur; Cocoa butter) 60%; and sugar replacing composition (resistant Dextrin 70%; XOS 10%; coconut extract 18%; Inulin 1.3%; rice extract (Rice Hull) 0.5%; Vanilla 0.2%]40% were added together.

The results yielded a semi-sweet dark chocolate with authentic taste and no aftertaste.

### Example 7: Milk Chocolate with Reduced Sugar Content

The following example was created in trials pertaining to reduce the content of sugar in Milk chocolate by fivefold from the typical content of 50% to 10% by weight of chocolate and create an authentically sweet milk chocolate with reduce sugar content and no aftertaste. In the making of this example, the composition along with the milk ingredients and sugar were added to a melted unsweetened chocolate comprising cocoa liqueur and cocoa butter, then combined into a blend which was processed through conching and tempering and molded into chocolate chips.

Unsweetened Chocolate (Cocoa Liqueur, Cocoa butter) 30%; Non-Fat Dry Milk 10%; Whole Milk powder 20%; and sugar replacing composition (Resistant Dextrin 76%, XOS 10%, Inulin 1.3%, Banana Extract 6%, Coconut Extract 6%, Rice extract (Rice Hull) 0.5%, Vanilla 0.2%) 30%; and sugar 10%.

Results: sweet Milk chocolate with authentic taste and no aftertaste.

### Example 8: Milk Chocolate with Reduced Sweeteners Content

The following example was created in trial pertaining to reduce the content of sweeteners such as Stevia in Milk chocolate by 3-5-fold from the typical content of 0.1% to 0.03%-0.02% by weight of chocolate, and create an authentically sweet Milk chocolate with no added sugar and no aftertaste. In the making of this example, the composition along with the milk ingredients and stevia were added to a melted unsweetened chocolate comprising cocoa liqueur and cocoa butter, then combined into a blend which was processed through conching and tempering and molded into chocolate chips.

Unsweetened chocolate (Cocoa Liqueur, Cocoa butter) 40%; Non-Fat Dry Milk 9.97%; Whole Milk powder 30%; sugar replacing composition (Resistant Dextrin 80%; XOS 10%; Inulin 3.5%; Banana extract 6%; Rice Extract (Rice Hull) 0.5%; Vanilla 0.2%) 20%; and Stevia RebM 0.02% were mixed.

Results: sweet Milk chocolate with authentic taste and no aftertaste.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A sugar replacing composition with no added sweeteners comprising:
digestion resistant soluble fiber having glucosyl moieties and/or fructosyl moieties, and/or xylosyl moieties, and present in an amount of 49% to 99% by weight of the composition;
dried coconut extract from the endosperm of coconut fruit namely coconut water in an amount of 6%-18% by weight of the composition; and
flavor agent comprising a dried rice extract and/or dried barley extract, and/or a dried vanilla flavor and/or a dried fruit extract, or a combination thereof, and the flavor agent present in an amount of 0.2% to 0.5% by weight of the composition.

2. The sugar replacing composition of claim 1, wherein the resistant soluble fiber is at least one of resistant dextrin and/or inulin and/or xylooligosaccharides, and the resistant dextrin is made without sugar alcohol processing aid, but may instead comprise a soluble fiber processing aid such as XOS and/or inulin comprised in a content of up to 18% by weight of resistant dextrin.

3. The sugar replacing composition of claim 1, wherein the digestion resistant soluble fiber is derived from a food source selected from the group consisting of tapioca, corn, potatoes, peas, banana, plantain, chicory, Jerusalem artichoke, or combinations thereof.

4. The sugar replacing composition of claim 1, wherein the digestion resistant soluble fiber is present along with or replaced by other digestive resistant material from the group consisting of digestion resistant oligomers such as isomaltooligosaccharides or galactooligosaccharides, or digestive resistant five carbon monomers such as xylose, or combination thereof, in an amount of 40%-95% by weight of the composition.

5. The sugar replacing composition of claim 1, wherein the coconut extract is replaced with dried banana extract and the dried banana extract is incorporated in the composition at the same percentage of the replaced coconut extract by weight of the composition.

6. The sugar replacing composition of claim 1, wherein the flavor agent is a food extract present in an amount of 8% to 17% by weight of the composition.

7. The sugar replacing composition of claim 1, further comprising at least one fruit extract.

8. The sugar replacing composition of claim 7, wherein the fruit extract is dried banana extract.

9. The sugar replacing composition of claim 7, wherein the fruit extract is present in an amount of 6%-18% by weight of the composition.

10. A method of creating a low calorie food material comprising:
adding sugar replacing composition comprising: digestion resistant soluble fiber comprising glycosyl moieties and/or fructosyl moieties, and/or xylosyl moieties, present in amount of 49% to 99% by weight of the composition;
adding dried coconut extract from the endosperm of the coconut fruit and/or a dried banana extract in an amount of 6% to 18% by weight of the composition; and
adding flavor agent comprising natural vanilla and/or rice extract and/or a barley extract and/or a vanilla flavor or a combination thereof, in an amount of 0.2% to 1.5% by weight of the composition.

11. The method according to claim 10,
wherein the food material is any food or nutritional product that is melted and/or softened and/or hardened and/or heated and cooled during making, wherein the food material is chocolate comprising cocoa liqueur and/or cocoa butter and/or dried milk and
further comprising adding a low glycemic sugar replacing composition according to claim 10, present in an amount of 15% to 45% by weight of the chocolate material along with dried Milk (Non-Fat and/or Whole Milk) whereas the dry milk is present in an amount of 2% to 20% by weight of dark chocolate and 20% to 40% by weight of milk or white chocolate.

12. The method according to claim 11, further comprising adding at least one dried fruit extract in an amount of 3% to 10% by weight of the food material.

13. The method according to claim 10, wherein the food material is an ingredient mix for baking and the composition is added in an amount of 10%-50% by weight of the ingredient mix.

14. The method according to claim 10, wherein the food material is an ingredient mix for ice-cream and the composition is added in an amount of 10% to 50% by weight of the ingredients mix.

15. The method according to claim 10, wherein the food material is an ingredient mix for baking, granola, cereal, puffed grains, trail mix, nutrition bar, candy bar, ice cream, whipped cream, beverage creamer, yogurt, frozen desert, custard, pudding, pie, bread, crackers, pastry, cake, nut butter, protein powder, meal replacement, vitamins, fruit powder, milk powder, cocoa beverage, tea beverage, coffee beverage, waffle, pancake, biscuit, tortilla, gummy bears and confection products, and the composition is added in an amount of 10% to 50% by weight of the ingredient mix.
